(19) United States
(12) Patent Application Publication
(10) Pub. No.: US 2003/0169133 A1
(43) Pub. Date: Sep. 11, 2003

(54) High frequency transmission line, electronic parts and electronic apparatus using the same

(75) Inventors: Makoto Torigoe, Yokohama (JP); Takashi Suga, Yokohama (JP); Kouichi Uesaka, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/222,186

(22) Filed: Aug. 15, 2002

(30) Foreign Application Priority Data
Mar. 8, 2002 (JP) 2002-063431

(51) Int. Cl. H01P 3/06; H01P 3/08

(52) U.S. Cl. 333/238; 333/243

(57) ABSTRACT

The invention provides a transmission line that is fabricated by forming the bottom base that is formed by means of a process in which a groove is formed on a circuit substrate, a conductive film is formed on the surface of the groove, the groove is filled with dielectric material, and a metal conductor is formed on the dielectric material, by forming the top base that is formed by means of a process in which a groove is formed, a conductive film is formed on the surface of the groove, and the groove is filled with dielectric material, and by putting the top base on the bottom base so that the metal conductor is interposed between the top base and the bottom base. Thereby, a transmission line with reduced leakage of the electromagnetic field is provided. Furthermore, an electronic parts or electronic apparatus with good high frequency performance that use the above-mentioned transmission line is provided.

### BACKGROUND OF THE INVENTION

1. Field of the Invention

This invention relates to a high frequency transmission line, and electronic parts and electronic apparatus that use the above-mentioned high frequency transmission line, and more particularly relates to a high frequency transmission technique.

2. Description of the Related Art

Conventional various products that are used as circuit substrates or transmission lines for transmitting the high frequency electric signals have been known and these are shown in FIG. 2, FIG. 3, FIG. 4, and FIG. 5.

FIG. 2A is a perspective view showing a conventional coplanar line and FIG. 2B is a side view of the coplanar line. A coplanar line has a signal conductor 201 formed on a dielectric material 203 as shown in FIG. 2A and FIG. 2B. Ground conductors 202a and 202b are provided on both sides of the signal conductor 201 to thereby confine the electromagnetic field between the signal conductor 201 and the ground conductor 202 for transmitting a signal.

FIG. 3A shows a perspective view of a conventional micro-strip line, and FIG. 3B shows a side view of the micro-strip line. A micro-strip line has a signal conductor 301 formed on a dielectric material 302 and a ground conductor 303 formed further on the dielectric material 302 on the opposite side with respect to the signal conductor 301 as shown in FIG. 3A and FIG. 3B to thereby confine the electromagnetic field between the signal conductor 301 and the ground conductor 303 for transmitting a signal.

FIG. 4A shows a perspective view of a conventional grounded coplanar line, and FIG. 4B shows the side view of the grounded coplanar line. A grounded coplanar line has ground conductors 402a and 402b on both sides of the signal conductor 401 and further has a ground conductor 404 on the opposite side with respect to the signal conductor 401 with interposition of a dielectric material 403 as shown in FIG. 4A and FIG. 4B to thereby confine the electromagnetic field between the signal conductor 401 and three ground conductors 402a, 402b and 404 for transmitting a signal. Furthermore, in the case of a grounded coplanar line, a through hole may be provided between the ground conductors 402a and 402b and the ground conductor 404 to connect them electrically together, though not shown in the drawing, so as to maintain the potential of the ground conductors 402a and 402b on both sides and ground conductor 404 at the same ground level.

A signal is transmitted through these transmission lines with confining the electromagnetic field between the signal conductor and the ground conductors. On a circuit substrate, a micro-strip line, coplanar line, and grounded coplanar line are frequently used because of easy production and high integration. However, these transmission lines are involved in some problems.

If a high frequency signal is transmitted using the coplanar line shown in FIG. 2A and FIG. 2B, the potential of the right and left ground conductors 202a and 202b cannot be maintained at the same ground level in some cases, and the different ground level of potential causes the poor transmission performance. To avoid this problem, the ground conductors 402a and 402b are electrically connected to the ground conductor 404 with the grounded coplanar line shown in FIG. 4A and FIG. 4B. Furthermore, these transmission lines radiate the partial electromagnetic field slightly to the outside. The radiated electromagnetic field adversely affects other electronic apparatuses. Furthermore, the radiated electromagnetic field reflects repeatedly in a box and this may cause a problem of the cavity resonance.

Furthermore, the transmission line is provided with a through hole to maintain the potential constant generally. In some cases, however, it is difficult or impossible to form a through hole depending on the type of the dielectric material 403. For example, Si substrate corresponds to the case. Furthermore, in some cases, there is no enough mounting space for forming a through hole. In these cases, it is difficult to maintain the potential of the right and left ground conductors constant.

Though the above-mentioned transmission lines radiate partial electromagnetic field slightly to the outside, the coaxial structure as shown in FIG. 5 is exemplified as a transmission line that does not leak the electromagnetic field to the outside.

FIG. 5 shows a perspective view of a conventional coaxial line. A coaxially structured transmission line comprises an inner conductor 501, an outer conductor 503, and a dielectric material 205 that surrounds the inner conductor 501 inside the outer conductor 503. Because a signal is transmitted with confining the electromagnetic field between the inner conductor and the outer conductor in the case of a coaxially structured transmission line, the electromagnetic field does not leak to the outside.

Furthermore, a line structure that is titled as “ground coplanar line grooved under the signal line” is shown in the 2002 Electronic Information Communication Society Integrated Meeting Collected Papers C-2-35 issued on Mar. 7, 2002. In this known example, a trapezoidal space is formed on the first substrate, metal is deposited on the surface of the first substrate including the portion of the trapezoidal space to form a bottom ground conductor, a dielectric material is filled therein and a signal conductor is formed on the dielectric material, the top ground conductor is formed on both sides of the signal conductor, and the bottom ground conductor and the top ground conductor are connected each other through a via to complete a ground coplanar line.

### SUMMARY OF THE INVENTION

If a through hole is provided to maintain the potential at the same ground level between ground conductors formed on both ends of the signal conductor, the providing of the through hole causes increased cost the more. Furthermore, if dielectric material, to which a through hole cannot be formed or can be formed but with difficulty, is used, it is difficult to maintain the potential at the same ground level between ground conductors formed on both ends of the signal conductor.

The outside diameter of the coaxially structured transmission line shown in FIG. 5 is structured so as to be cylindrical. When the line is to be connected to a flat IC, a large space is therefore required after the connection because the configuration is different from each other.

For the ground coplanar line shown in the 2002 Electronic Information Communication Society Integrated Meeting Collected Papers, leakage of electromagnetic wave is prevented because the bottom ground conductor and the top ground conductor surround the signal conductor. However, it is necessary to form the bottom ground conductor, to fill the dielectric material thereon, and further to form the top grand conductor and signal conductor on the dielectric material, and many processes are required to complete the line of this type. Furthermore, the via is formed between the top ground conductor and the bottom ground conductor. Because the via is formed discontinuously in the direction to which the electromagnetic field proceeds through the signal conductor, the density of electric lines of force that proceeds to the ground conductor and via from the signal conductor is significantly different depending on the place in the view on the cross section in the direction perpendicular to each point of the signal conductor. Therefore, the reflection is apt to occur, and the transmission performance may deteriorate.

The present invention has been accomplished to solve the above-mentioned problem, and it is an object of the present invention to provide a transmission line that is capable of maintaining the ground potential constant without forming a through hole to improve the transmission performance.

The present invention has been accomplished to solve the above-mentioned problem, and it is another object of the present invention to provide a transmission line that is capable of reducing leakage of the electromagnetic field.

Furthermore, it is still another object of the present invention to provide electronic parts or electronic apparatus with reduced leakage of the electromagnetic field.

To achieve the objects of the present invention, a groove is formed on a circuit substrate, a conductive film is formed on the surface of the groove, the groove is filled with dielectric material, and a metal film is formed on the dielectric material. Furthermore, a conductive film is formed on both sides of the groove continuously to the conductive film that has been formed on the surface of the groove of the transmission line.

Furthermore, a groove is made on a circuit substrate, a conductive film is formed on the surface of the groove, the groove is filled with dielectric material, a metal conductor is formed on the dielectric material, and a top half that is formed by making a groove with a conductive film filled with dielectric material similarly is put on the bottom half that has been formed as described above to realize a transmission line of the present invention.

According to the above-mentioned present invention, a through hole need not be formed to maintain the potential constant using the conventional techniques. Furthermore, the transmission line of the present invention is capable of transmitting a signal with confining the electromagnetic field inside the groove without leakage of the electromagnetic field to the outside.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 is a perspective view showing an exemplary high frequency transmission line according to the present invention;

FIG. 2A is a perspective view showing a conventional coplanar line, and FIG. 2B is a side view showing the conventional coplanar line;

FIG. 3A is a perspective view showing a conventional micro-strip line, and FIG. 3B is a side view of the conventional micro-strip line;

FIG. 4A is a perspective view of a conventional grounded coplanar line, and FIG. 4B is a side view of the conventional grounded coplanar line;

FIG. 5 is a perspective view showing a conventional coaxial line;

FIG. 6A to FIG. 6F are cross sectional views for describing a manufacturing process of a high frequency transmission line according to the present invention;

FIG. 7 is a perspective view showing the connection structure between the high frequency transmission line according to the present invention and an IC;

FIG. 8 is a perspective view showing another exemplary high frequency transmission line according to the present invention;

FIG. 9 is a perspective view showing a further exemplary high frequency transmission line according to the present invention;

FIG. 10 is a side view showing a further example according to the present invention;

FIG. 11 is a side view showing still another exemplary high frequency transmission line according to the present invention; and

FIG. 12 is a side view showing yet another exemplary high frequency transmission line according to the present invention.

### DESCRIPTION OF THE PREFERRED EMBODIMENTS

Embodiments of the present invention will be described below in detail with reference to the accompanying drawings.

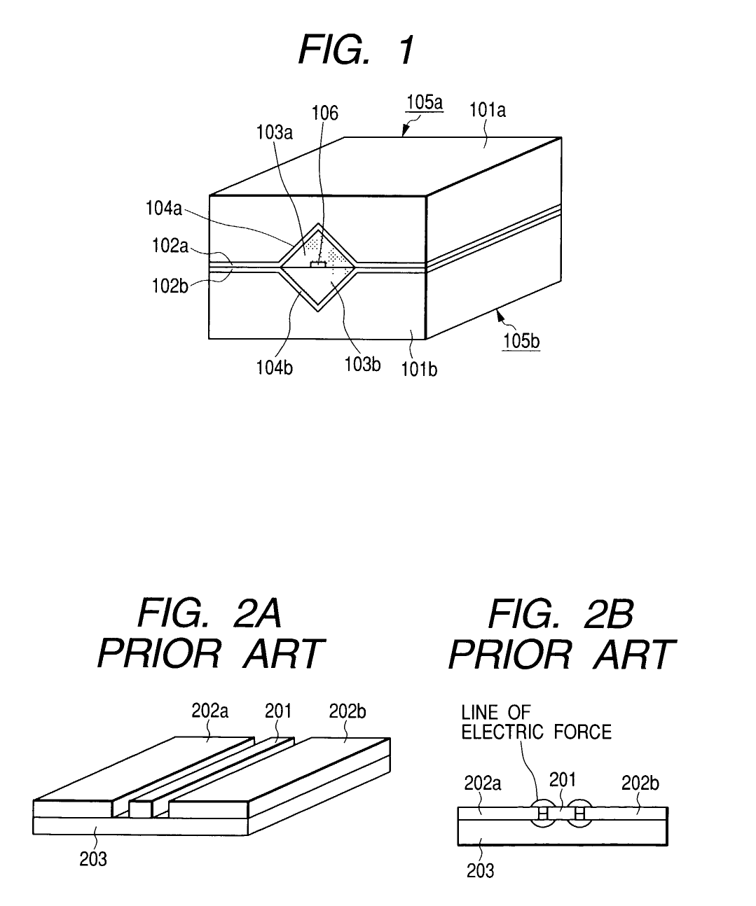

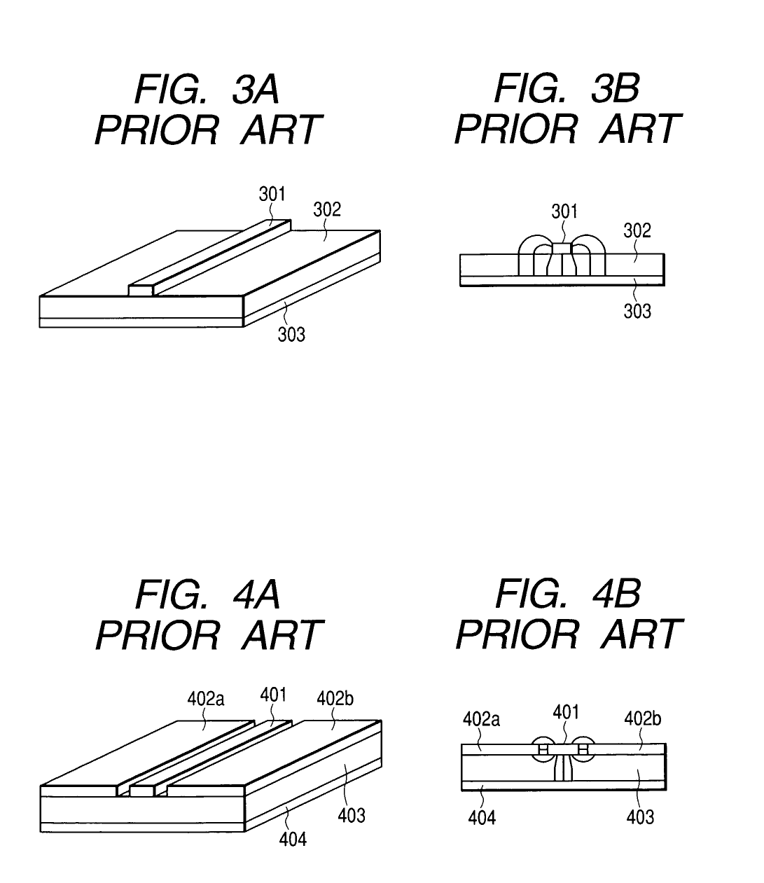

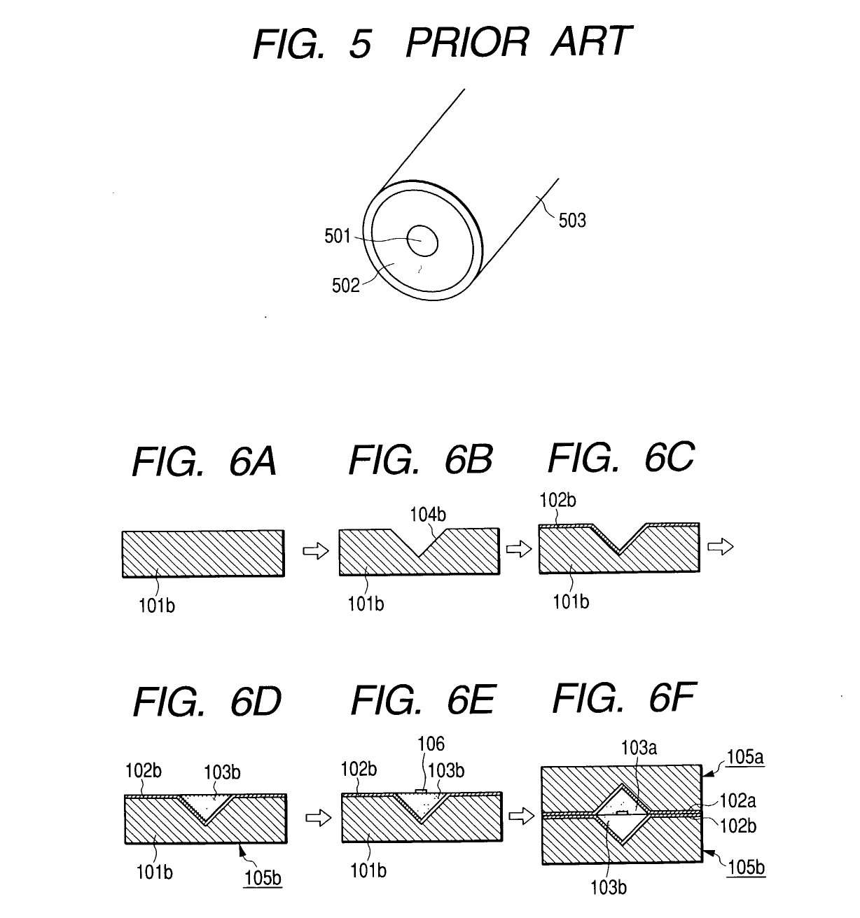

FIG. 1 is a perspective view showing one embodiment of the high frequency transmission line according to the present invention. As shown in FIG. 1, a transmission line of the present embodiment has V-shaped grooves 104a and 104b on a substrate 101a and a substrate 101b, respectively. In addition, metal films 102a and 102b are formed on the surface of the substrates 101a and 101b on which the V-shaped grooves 104a and 104b are formed, respectively. Furthermore, dielectric resins 103a and 103b are filled in the grooves 104a and 104b on which the metal films 102a and 102b are formed, respectively. As described above, the transmission line of the present embodiment has the structure that two bases 105a and 105b formed by means of a process in which the metal films 102a and 102b are formed on the grooves 104a and 104b and further dielectric resin 103 is filled in the grooves 104a and 104b are prepared and a signal conductor 106 is interposed between the two bases 105a and 105b. In other words, the signal conductor 106 is disposed on the dielectric resin at the center of any one base of the bases 105a and 105b, and the other base is put on the one base so that the signal conductor 106 is interposed between the dielectric resins 103a and 103b of the respective bases 105a and 105b to compose the high frequency transmission line. The metal films 102a and 102b function as the ground conductor.

The use of the present embodiment easily forms a transmission line surrounded by the ground conductor is formed easily on a circuit substrate, and a transmission line with reduced leakage of the electromagnetic field.

The manufacturing process of the high frequency transmission line according to the present invention will be described below with reference to FIGS. 6A to 6F.

FIG. 6A and FIG. 6B are cross sectional views for describing the manufacturing process of a high frequency transmission line according to the present invention. As shown in FIG. 6A, a base 101b is prepared. Next, as shown in FIG. 6B, a V-shaped groove 104b is formed on a substrate 101b. The groove may be formed by a forming method such as drilling, laser, or etching. Next, as shown in FIG. 6C, the surface of the substrate 101b including the V-shaped groove 104b is metalized to form the metal film 102b. Plating and evaporation are exemplified as the metalizing technique. Next, as shown in FIG. 6D, dielectric resin 103b is filled in the V-shaped groove 104b on the metal film 102b to form the one base 105b. Glass-epoxy resin is exemplified as the resin. Next, as shown in FIG. 6E, the signal conductor 106 is formed on the dielectric resin 103b. Thereby, the potential of the right and left ground conductors are maintained at the same ground level, and as the result a transmission line having good transmission performance is formed. This structure may be used even for the substrate on which a through hole cannot be formed or can be formed but with difficulty.

Plating, evaporation, and etching are exemplified as a method for forming the signal conductor 106. Finally, as shown in FIG. 6F, the other base 105a having the same structure as shown in FIG. 6D, on which a hole is formed for accommodating the insertion of the signal conductor 106 on the part that corresponds to the signal conductor 106 of the dielectric material 103b, is put one on the other so as to interpose the signal conductor 106 between the dielectric resins 103a and 103b. As the result, a high frequency transmission line can be structured such that the signal conductor 106 is surrounded by the conductor 102a and 102b.

There is provided a method of using anisotropic etching speed of silicone as the method for precisely forming the V-shaped grooves 104a and 104b. In other words, the etching speed difference depending on the silicone crystal orientation is utilized to form the V-shaped groove efficiently with high precision.

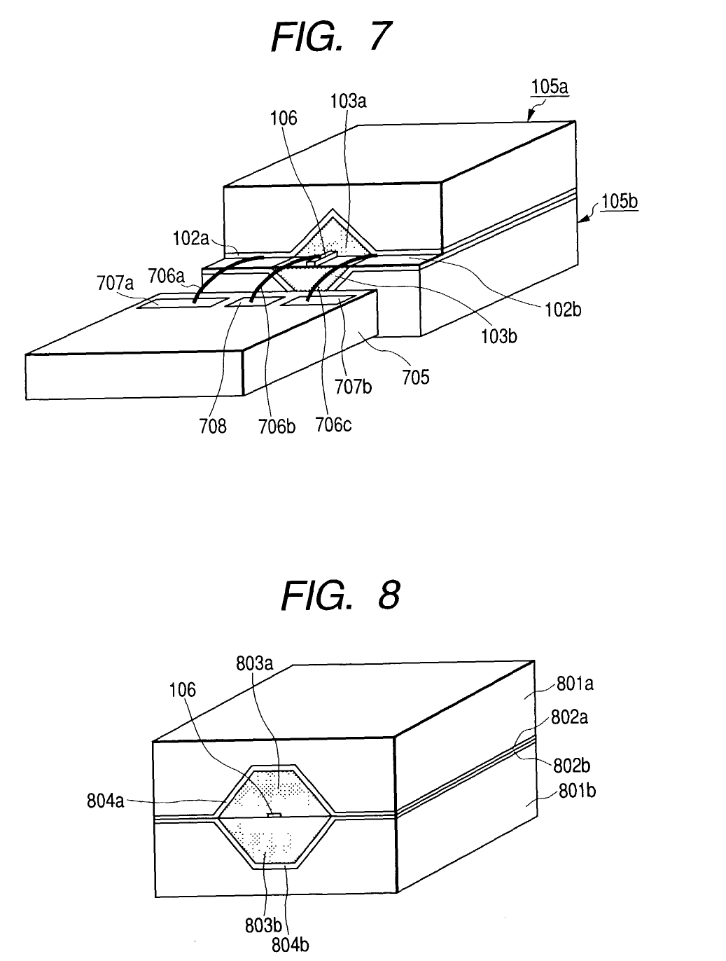

FIG. 7 is a perspective view showing the connection structure between a high frequency transmission line according to the present invention and an IC. As shown in FIG. 7, the high frequency transmission line having one base that is projected from the end face of the other base is connected to the IC. For example, the top base 105a of the high frequency transmission line is cut partially to thereby expose the metal film 102b of the bottom base 105b on both sides of the dielectric material 103b, and the signal conductor 106 is exposed at the center of the dielectric material 103b. The metal films 102a and 102b on both sides are connected to the ground electrodes 701a and 707b respectively using bonding wires 706a and 706c. Furthermore, the signal conductor 106 is connected to the signal electrode 708 of the IC 705 using a bonding wire 706b.

According to the present embodiment, the IC 705 or another transmission line is connected easily. In the present embodiment, the connection method using a bonding wire 706 is shown. A ball grid alley (BGA) type IC, namely an IC that has a solder ball on the backside of the IC, can be connected as it is without using a bonding wire.

Furthermore, in the case of a transmission line having the micro-strip structure in which there are a plurality of signal conductors, crosstalk between transmission lines is problematic. However, in the present embodiment, a transmission line is enclosed perfectly. Therefore, the coupling to another transmission line is reduced, and the crosstalk is also reduced.

For the transmission line according to the present invention, the configuration of the groove is by no means limited to a V shape, but may be otherwise shaped.

FIG. 8 is a perspective view showing another embodiment of the high frequency transmission line according to the present invention. As shown in FIG. 8, trapezoidal grooves 804a and 804b are formed on substrates 801a and 801b, respectively. Metal films 802a and 802b are formed on the surface of the substrates 801a and 801b including the trapezoidal grooves 804a and 804b. Dielectric materials 803a and 803b are then filled in the trapezoidal grooves 804a and 804b, and a signal conductor 106 is provided on the dielectric material 803b.

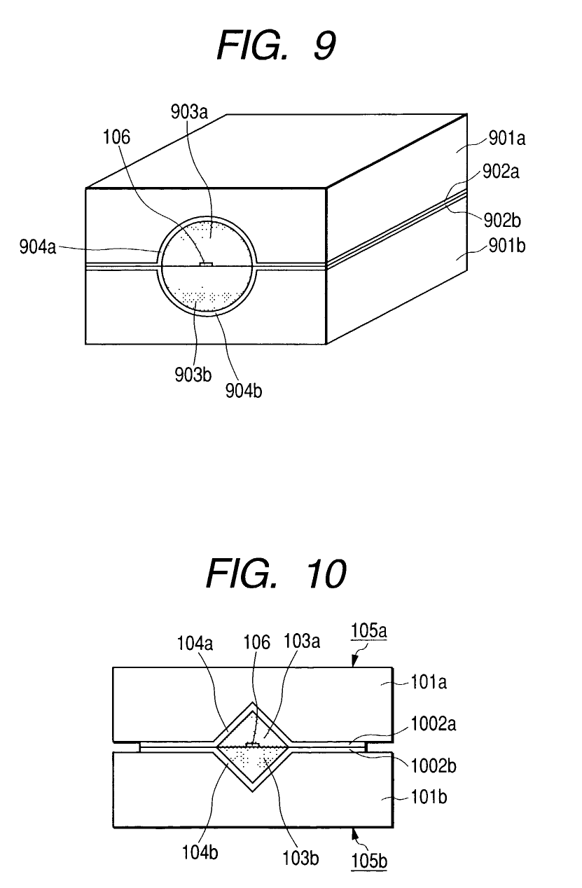

FIG. 9 is a perspective view showing still another embodiment of the high frequency transmission line according to the present invention. As shown in FIG. 9, semicircular grooves 904a and 904b are formed on substrates 901a and 901b, respectively, and other structure is formed in the same manner as applied to the embodiment of the high frequency transmission line shown in FIG. 8. Numerals 902a and 902b denote metal films, respectively, and numerals 903a and 903b denote dielectric material, respectively.

In the present invention, the configuration of the groove may be trapezoidal as shown in FIG. 8, or may be semicircular as shown in FIG. 9, or further may be U-shaped curved.

Furthermore, in the present invention, it is not necessary that the metal film extends to cover the whole width of the substrate.

FIG. 10 is a side view showing still another embodiment of the present invention. The same components as used in FIG. 1 are given the same characters, and the description is omitted. In FIG. 10, the width of metal films 1002a and 1002b is slightly narrower than the width of substrates 101a and 101b, respectively.

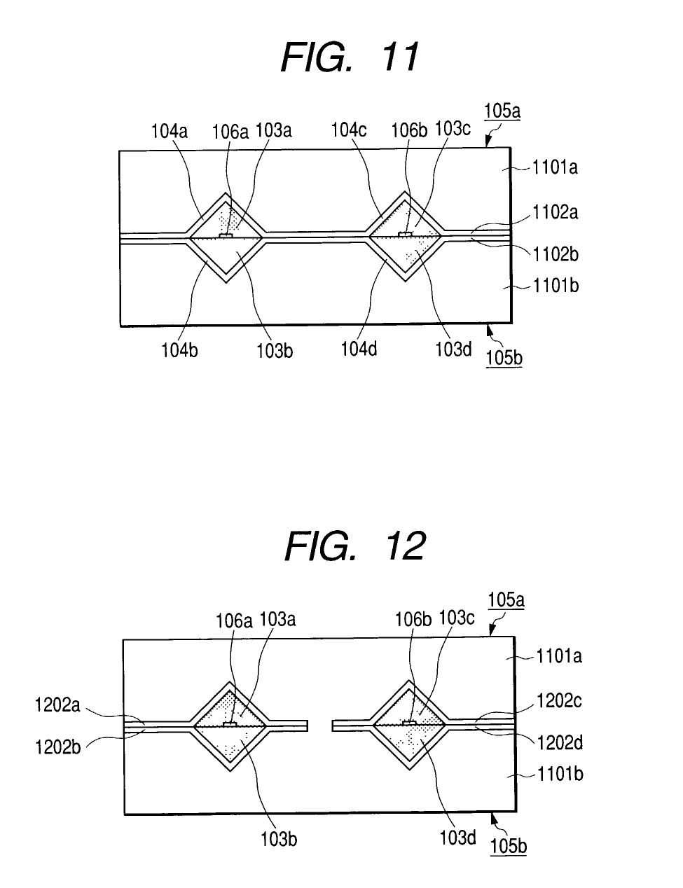

In the above-mentioned examples, one groove is formed on one substrate, and one signal conductor is provided on dielectric material filled in the groove. However, a plurality of signal conductors may be provided. An exemplary high frequency transmission line having two signal conductors is shown in FIG. 11, and a plurality of signal conductors may be provided arbitrarily.

FIG. 11 is a side view showing yet another embodiment of the high frequency transmission line according to the present invention. First and second grooves 104a and 104c are formed on a substrate 1101a, first and second grooves 104b and 104d are formed on a substrate 1101b, and metal films 1102a and 1102b are formed on the surface of the substrates 1101a and 1101b. Dielectric materials 103a to 103d are filled in the grooves 104a to 104d respectively, a signal conductor 106a is interposed between the dielectric material 103a of the substrate 1101a and the dielectric material 103b of the substrate 1101b, and another signal conductor 106b is interposed between the dielectric material 103c of the substrate 1101a and the dielectric material 103d of the substrate 1101b. As described above, a plurality of signal conductors may be provided.

FIG. 12 is a side view showing still another embodiment of the high frequency transmission line according to the present invention. In FIG. 12, the metal film is cut between a signal conductor 106a and another signal conductor 106b, and the metal film is not conductive between both signal conductors 106a and 106b. In other words, the metal film 1202a is separated from the metal film 1202c, and the former is not electrically conductive to the latter. Furthermore, the metal film 1202b is separated from the metal film 1202d, and the former is not electrically conductive to the latter.

For the high frequency transmission line shown in the present embodiment, for example, if a high speed signal is transmitted through the signal conductor 106a and a low speed signal is transmitted through the signal conductor 106b, and the metal film 1202a is connected to the metal film 1202c and the metal film 1202b is connected to the metal film 1202d, the noise due to the high speed signal affects the signal transmitted through the signal conductor 106b adversely. In this case, the adverse effect is prevented by insulating between the metal film 1202a and the metal film 1202c and by insulating between the metal film 1202b and the metal film 1202d as shown in FIG. 12.

On the other hand, if high speed signals are transmitted through both the signal conductors 106a and 106b, the metal film is preferably combined as for the metal films 1102a and 1102b shown in FIG. 11.

The present invention may be applied to a high speed signal transmission substrate of an optical module, personal computer, mobile terminal, and communication apparatus as an apparatus for transmitting the high frequency signal.

Exemplary transmission lines formed on substrates are shown in the above-mentioned embodiments, but the present invention is not limited to these embodiments. The present invention is applied to a transmission line in an LSI chip, and an LSI with good high frequency performance is realized thereby. Furthermore, the present invention can be applied to a flexible cable for connecting between substrates.

As described above, according to the present invention, dielectric material, on which a through hole cannot be formed or can be formed but with difficultly, can be used because the structure shown in FIG. 6E is effective to maintain the potential of the ground conductors disposed on both sides of a signal conductor in a constant level without forming a through hole.

Furthermore, according to the present invention, a transmission line with reduced leakage of the electromagnetic field is realized.

In detail, according to the present invention, a groove is formed on a circuit substrate, a conductive film is formed on the surface of the groove, the groove is filled with dielectric material, and a metal film that functions as a signal conductor is formed on the dielectric material. Furthermore, in the present invention, conductive films are formed on both sides of the groove continuously to the conductive film formed on the surface of the groove. In other words, the ground conductor is formed on the surface of the groove and substrate. Thereby, the potential of the ground conductors disposed on both sides of the signal conductor is maintained at the same ground level.

Furthermore, the bottom base is formed by means of a process in which a groove is formed on a circuit substrate, a conductive film is formed on the surface of the groove, the groove is filled with dielectric material, a metal conductor is formed on the dielectric material, and the top base that is formed by means of a process in which a groove is formed, a conductive film is formed on the surface of the groove, and the groove is filled with dielectric material, is put on the bottom base so that the metal conductor is interposed between the top base and the bottom base. Thereby, a signal can be transmitted with confining the electromagnetic field in the groove, and a signal can be transmitted without leakage of the electromagnetic field to the outside.

As described above, according to the present invention, the potential of the ground conductors disposed on both sides of the signal conductor is maintained at the same ground level.

Furthermore, a signal can be transmitted with confining the electromagnetic field in the groove, and a signal can be transmitted with reduced leakage of the electromagnetic field.

The invention may be embodied in other specific forms without departing from the spirit or essential characteristics thereof. The present embodiment is therefore to be considered in all respects as illustrative and not restrictive, the scope of the invention being indicated by the appended rather than by the foregoing description and all changes which come within the meaning and range of equivalency of the claims are therefore intended to be embraced therein.

What is claimed is:

1. A transmission line comprising: a substrate having a groove, a conductive film formed on the surface of said groove, dielectric material disposed on said conductive film of said groove so as to fill said groove, and a signal conductor provided on said dielectric material.

2. The transmission line as claimed in claim 1, wherein conductive films are formed on both sides of said groove continuously to said conductive film formed on the surface of said groove.

3. A transmission line comprising: a first base having a substrate on which a groove is formed, a conductive film that is served as the ground electrode formed on the surface including said groove of said substrate, and dielectric material disposed on said conductive film of said groove portion, a second base having another substrate on which another groove is formed, another conductive film that is served as the ground electrode formed on the surface including said another groove of said another substrate, and another dielectric material disposed on said another conductive film of said another groove portion, and a signal conductor, wherein said signal conductor is surrounded by dielectric material of said first base and dielectric material of said second base.

4. The transmission line as claimed in claim 3, wherein any one of said first base and said second base is projected from the end face of another base to expose the conductive film of said projected base and said signal conductor.

5. The transmission line as claimed in claim 1, wherein the configuration of said groove is any one of a polygon and a curved shape such as a semicircle or U-shape.

6. The transmission line as claimed in claim 2, wherein the configuration of said groove is any one of polygonal and curved shape such as semicircular or U shape.

7. The transmission line as claimed in claim 3, wherein the configuration of said groove is any one of a polygon and a curved shape such as a semicircle or U shape.

8. The transmission line as claimed in claim 4, wherein the configuration of said groove is any one of a polygon and a curved shape such as a semicircle or U shape.

9. The transmission line as claimed in claim 1, wherein a plurality of grooves and signal conductors are provided on said substrate.

10. Electronic parts having a transmission line as claimed in claim 1.

11. Electronic parts having a transmission line as claimed in claim 2.

12. Electronic parts having a transmission line as claimed in claim 3.

13. Electronic parts having a transmission line as claimed in claim 4.

14. Electronic parts having a transmission line as claimed in claim 9.

15. An electronic apparatus having a transmission line as claimed in claim 1.

16. An electronic apparatus having a transmission line as claimed in claim 2.

17. An electronic apparatus having a transmission line as claimed in claim 3.

18. An electronic apparatus having a transmission line as claimed in claim 4.

19. An electronic apparatus having a transmission line as claimed in claim 9.
